(19) United States
(12) Patent Application Publication
(10) Pub. No.: US 2025/0265066 A1
(43) Pub. Date: Aug. 21, 2025

(54) TECHNIQUES FOR MANAGING IMAGES ASSOCIATED WITH SOFTWARE APPLICATIONS

(71) Applicant: Apple Inc., Cupertino, CA (US)

(72) Inventors: Jia HUANG, Mountain View, CA (US); Anikesh KAMATH, Sunnyvale, CA (US); Babak Seyed AGHAZADEH, Fremont, CA (US); Dayvid Victor RODRIGUES DE OLIVEIRA, Round Rock, TX (US); Justin M. PLATZ, New York, NY (US); Kanishka BHADURI, Sunnyvale, CA (US); Milind Pandurang JAGRE, Georgetown, TX (US); Robert J. MONARCH, San Francisco, CA (US); Yuan Yen TAI, Pleasanton, CA (US); Xiaoyuan GU, San Jose, CA (US); Alex J. KIM, Mukilteo, WA (US)

(21) Appl. No.: 19/060,399

(22) Filed: Feb. 21, 2025

Related U.S. Application Data
(60) Provisional application No. 63/556,382, filed on Feb. 21, 2024.

(51) Int. Cl. G06F 8/61

(52) U.S. Cl. CPC G06F 8/63

(57) ABSTRACT

A method for managing images associated with software applications is disclosed. The method implemented by a computing device can include receiving an original image associated with a software application, extracting a foreground element from the original image to produce an extracted foreground element and a modified original image. The method further includes generating multiple candidate images based on the extracted foreground image, the modified original image, and a keyword associated with the original image. Additionally, the method includes generating, based on the keyword, respective quality scores for the multiple candidate images, filtering the multiple candidate images using their respective quality scores to generate one or more filtered candidate images, and associating the at least one of the one or more filtered candidate images with the software application.

### CROSS-REFERENCE TO RELATED APPLICATIONS

The present application claims the benefit of U.S. Provisional Application No. 63/556,382, entitled “TECHNIQUES FOR MANAGING IMAGES ASSOCIATED WITH SOFTWARE APPLICATIONS,” filed Feb. 21, 2024, the content of which is incorporated by reference herein in its entirety for all purposes.

### FIELD

The described embodiments relate generally to managing images associated with software applications.

### BACKGROUND

It can be beneficial for digital assets—such as marketing images—to accurately portray and capture the essence of software applications. However, producing such digital assets is typically costly and time consuming. For example, to reflect the keywords “fast food” and “vegetarian,” distinct images need to be gathered/produced, merged together in an aesthetically pleasing way, and so on, which can be a challenging endeavor for those who lack design expertise or confidence.

In view of the large volume of search terms frequently provided by users, trying to create digital assets, customize them, and evaluate them, presently requires substantial human involvement. In some cases, emerging unsupervised text-to-image generation models can help improve the overall efficiency of such processes. However, such approaches models frequently generate distorted, unrealistic, or even inappropriate images, which can lead to a poor user experience.

Accordingly, what is needed is an improved technique for managing images associated with software applications.

### SUMMARY

The described aspects relate generally to managing images associated with software applications.

One aspect sets forth a method for managing images associated with software applications. The method can be implemented by a computing device, and includes the steps of receiving an original image associated with a software application, where the original image includes at least one foreground element, and extracting the at least one foreground element from the original image. In some aspects, extracting the at least one foreground element comprises: producing an extracted at least one foreground element, and removing the extracted at least one foreground element from the original image to produce a modified original image. The steps can further include generating two or more candidate images based on the extracted at least one foreground element, the modified original image, and at least one keyword associated with the original image. Additionally the steps can include generating, based at least in part on the at least one keyword, respective quality scores for the two or more candidate images, filtering the two or more candidate images based on the respective quality scores to produce one or more filtered candidate images, and associating at least one of the one or more filtered candidate images with the software application.

Other aspects include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects described herein will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 illustrates a block diagram of different components of a system that can be configured to implement the various techniques described herein, according to some embodiments.

FIGS. 2A-2C illustrate conceptual diagrams for generating images associated with software applications, according to some embodiments.

FIGS. 3A-3B illustrate conceptual diagrams for managing images associated with software applications in an online software application store, according to some embodiments.

FIG. 4 illustrates a method for generating images associated with software applications, according to some embodiments.

FIG. 5 illustrates a detailed view of a computing device that can be used to implement the various components described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

The described embodiments relate generally to managing images associated with software applications. In particular, the embodiments set forth techniques for automatically generating and filtering images that are relevant to software applications. For example, given an original image—e.g., a software application screenshot, marketing image, etc.—the techniques can involve masking out key components to be maintained in a candidate (i.e., updated/enhanced) image, generating new/updated image content, and then performing a merging operation to generate the candidate image. These steps can be repeated, modified, etc., to generate a series of candidate images that may constitute enhanced versions, variations, etc., of the original image.

According to some embodiments, the embodiments can employ a diffusion model that is tuned using a set of (image, text) pairs that have been deemed to be relevant/appropriate to the types of images described herein. Such tuning can effectively establish a bounded generation process, which can help avoid the generation of inappropriate or policy-violating images. Additionally, the candidate images can be provided to an automatic image selection module that is trained on matching between (image, text) pairs. In this manner, quality scores can be generated for each candidate image, and one or more images having the strongest quality scores can be selected (e.g., automatically, by one or more users, etc.). In turn, the selected images can be associated with a given software application (e.g., displayed within a product page for the software application within an online software application store, within a website for the software application, within an advertisement associated with the software application, etc.).

Accordingly, the techniques described herein can beneficially provide automatic image generation, enhancement, and recommendation features that can help streamline content generation for software applications.

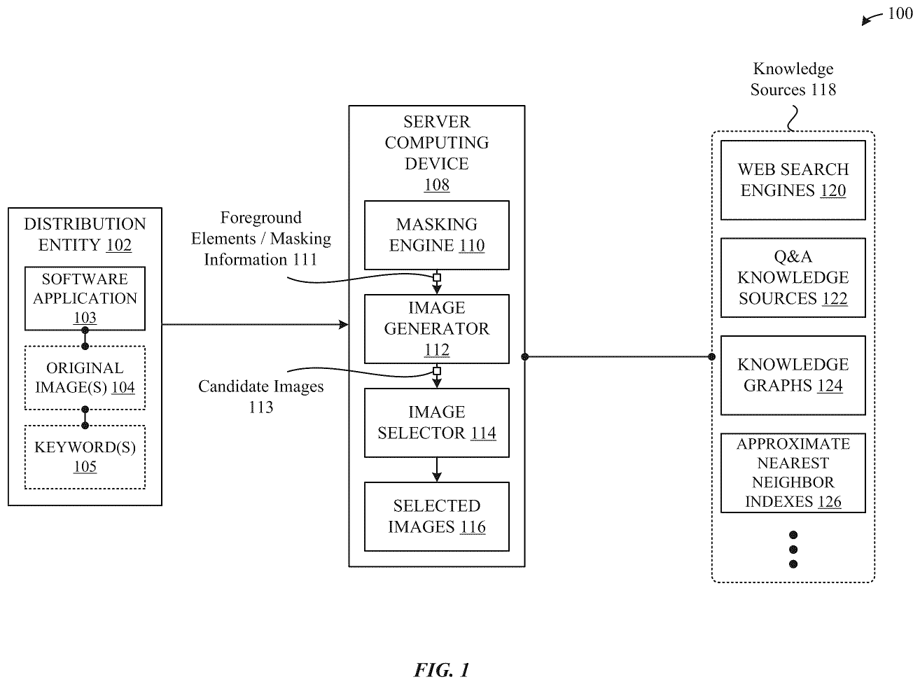

FIG. 1 illustrates a block diagram of different components of a system 100 that can be configured to implement the various techniques described herein, according to some embodiments. As shown in FIG. 1, the system 100 can include a distribution entity 102 and a server computing device 108. It is noted that, in the interest of simplifying this disclosure, the distribution entity 102 and the server computing device 108 are discussed in singular capacities. In that regard, it should be appreciated that the system 100 can include any number of distribution entities and server computing devices, without departing from the scope of this disclosure.

According to some embodiments, the distribution entity 102 and the server computing device 108 can represent any form of computing device operated by an individual, an entity, etc., such as a wearable computing device, a smartphone computing device, a tablet computing device, a laptop computing device, a desktop computing device, a rack mount computing device, a gaming computing device, a smart home computing device, an Internet of Things (IOT) computing device, and so on. It is noted that the foregoing examples are not meant to be limiting, and that the distribution entity 102/server computing device 108 can represent any type, form, etc., of computing device, without departing from the scope of this disclosure.

According to some embodiments, the distribution entity 102 can collectively represent one or more parties involved in the development, management, publication, etc., of software applications 103. For example, the distribution entity 102 can collectively represent a company, individual developers, and so on, as well as one or more computing devices that are utilized by such parties. As shown in FIG. 1, each software application 103 can optionally be associated with original images 104, which can include, for example, screenshots of the software application 103, marketing images relevant to the software application 103, and so on. According to some embodiments, each original image 104 can be associated with keywords 105, which can include, for example, text that describes the original image 104, text that describes the functionalities, categories, etc., of the software application 103, and so on. As described in greater detail herein, the original images 104 and keywords 105 associated with a given software application 103 can enable a bounded image generation process to be utilized to generate relevant and appropriate images for the software application 103.

As shown in FIG. 1, the distribution entity 102 can submit a software application 103 to the server computing device 108 to be included in an online software application store (hereinafter, “OSAS”) (e.g., implemented by the server computing device 108, and/or by other server devices). According to some embodiments, when a submission is made, the distribution entity 102 can provide original images 104 and keywords 105 associated with the software application 103. Alternatively, or additionally, original images 104 and keywords 105 can be automatically generated for the software application 103. For example, one or more entities (e.g., the distribution entity 102, the server computing device 108, and/or other entities) can execute the software application 103, analyze its components, assets, logic, etc., to extract relevant screenshots from the software application 103 (e.g., screenshots of a primary UI, screenshots of relevant features, etc.), to identify relevant keywords, and so on, for the software application 103. In turn, the extracted information can be provided to one or more image processing engines, image generation engines, etc., to output original image 104, keywords 105, and so on. This approach can be beneficial in that it effectively eliminates or reduces the need for distribution entities 102 to generate, review, and provide original images 104 and keywords 105 when submitting software applications 103 to the OSAS.

As a brief aside, it is noted that embodiments described herein can employ various image engines to generate, enhance, etc., images, each with its own unique approach and characteristics. For example, traditional rendering engines, like rasterization engines, can use algorithms to convert 3D models into 2D images by calculating the color of each pixel based on the geometry and lighting information, which can be useful to generate screenshots from a given software application 103. In another example, procedural generation engines can create images algorithmically, which can be useful to generate textures, patterns, and backgrounds. In yet another example, machine learning-based engines, such as Generative Adversarial Networks (GANs) or Variational Autoencoders (VAEs), can be used to generate images by learning patterns and features from existing data, thereby allowing for the creation of novel and diverse visual content. Each type of image engine offers its own advantages and is suited to different applications, ranging from real-time graphics to artistic expression and content creation. It is noted that the foregoing examples are not meant to be limiting, and that the image engines described herein can include any number, type, form, etc., of image engines, at any level of granularity, consistent with the scope of this disclosure. It is also noted that any of the foregoing (as well as other) image engines can be utilized individually or together without departing from the scope of this disclosure.

Additionally, it is noted that conversation history information can be maintained between the distribution entity 102 and the server computing device 108, and can represent/store other information associated with a user/the users of the distribution entity 102, such as user account information, demographic-related information, device-related information (associated with the distribution entity 102), and so on. According to some embodiments, the conversation history information can be stored locally on the distribution entity, server computing device 108 (e.g., where appropriate authorization to do so has been provided), and/or any other computing devices, which can improve overall efficiency, enable synchronization functionalities, and so on. According to some embodiments, the conversation history information can be utilized to reflect preferences of the distribution entity 102 when generating images in accordance with the techniques described herein. For example, the conversation history information can include information about selections, feedback, etc., provided in association with a given user, distribution entity 102, etc., so that the processes described herein can provide images that appropriately align with observed preferences.

According to some embodiments, and as shown in FIG. 1, the server computing device 108 can implement a masking engine 110, an image generator 112, and an image selector 114. According to some embodiments, one or more of the masking engine 110, image generator 112, and image generator 112 can implement one or more artificial intelligence (AI) models-such as small language models (SLMs), large language models (LLMs), rule-based models, traditional machine learning models, custom models, ensemble models, knowledge graph models, hybrid models, domain-specific models, sparse models, transfer learning models, symbolic artificial intelligence (AI) models, generative adversarial network models, reinforcement learning models, biological models, and the like. It is noted that the foregoing examples are not meant to be limiting, and that any number, type, form, etc., of AI models, can be implemented by any of the entities illustrated in FIG. 1, without departing from the scope of this disclosure. It is also noted that the aforementioned entities can represent non-AI-based entities, such as rules-based systems, knowledge-based systems, and so on.

Additionally, one or more of the masking engine 110, the image generator 112, and the image selector 114 can be configured to interface with knowledge sources 118 to enable, enhance, etc., their associated features. According to some embodiments, and as shown in FIG. 1, the knowledge sources 118 can include, for example, web search engines 120, question and answer (Q&A) knowledge sources 122, knowledge graphs 124, approximate nearest-neighbor indexes 126, and so on. It is noted that the knowledge sources 118 illustrated in FIG. 1 and described herein are not meant to be limiting, and that server computing device 108 (as well as the other entities described herein) can be configured to access any type, kind, form, etc., of knowledge source 118 that is capable of receiving queries and providing responses, without departing from the scope of this disclosure. It should also be understood that the knowledge sources 118 can employ any number, type, form, etc., of AI models (or non-AI based approaches) to provide the various functionalities described herein, without departing from the scope of this disclosure. It should also be understood that the knowledge sources 118 can be implemented by any computing entity (e.g., the distribution entity 102, the server computing device 108, etc.), service (e.g., cloud services), etc., without departing from the scope of this disclosure.

According to some embodiments, the web search engines 120 can represent web search entities that are capable of receiving queries and providing answers based on what is accessible via the Internet. To implement this functionality, the web search engines 120 can “crawl” the Internet, which involves identifying, parsing, and indexing the content of web pages, such that relevant content can be efficiently identified in response to search queries that are received. According to some embodiments, the Q&A knowledge sources 122 can represent systems, databases, etc., that can formulate answers to questions that are commonly received. To implement this functionality, the Q&A knowledge sources 122 typically rely on structured or semi-structured knowledge bases that contain a wide range of information, facts, data, or textual content that is manually curated, generated from text corpora, or collected from various sources, such as books, articles, databases, or the Internet.

According to some embodiments, the knowledge graphs 124 can represent systems, databases, etc., that can be accessed to formulate answers to queries that are received. A given knowledge graph 124 typically constitutes a structured representation of knowledge that captures relationships and connections between entities, concepts, data points, etc. in a way that computing devices are capable of understanding. According to some embodiments, the approximate nearest-neighbor indexes 126 can represent systems, databases, etc., that can be accessed to formulate answers to queries that are received. A given index of approximate nearest-neighbor indexes 126 typically constitutes a data structure that is arranged in a manner that enables similarity searches and retrievals in high-dimensional spaces to be efficiently performed. This makes the approximate nearest-neighbor indexes 126 particularly useful when performing tasks that involve information retrieval, recommendations, and finding similar data points, objects, and so on.

According to some embodiments, and as shown in FIG. 1, the masking engine 110 can be configured to identify foreground elements/masking information 111 within a given original image 104. Under one example approach, the masking engine 110 can implement a pipeline that includes foreground element detection, segmentation, and mask post-processing operations. According to some embodiments, the foreground element detection operations can involve utilizing a pre-trained detection model (e.g., a CenterNet model) to identify foreground elements included in the original image 104 (e.g., buttons, checkboxes, radio buttons, text fields, dropdown menus, sliders, progress bars, tooltips, accordions, tabs, modal windows, breadcrumbs, pagination, switches, tags, badges, alerts, spinners, loaders, cards, carousels, lists, tables, grids, avatars, icons, thumbnails, navigation bars, sidebars, footers, tooltips, breadcrumbs, search bars, date pickers, time pickers, file uploaders, rating systems, calendars, wizards, tree views, chat interfaces, etc.). The UI detection operations can also involve detecting screenshots of software applications, computing devices that execute the software applications, and so on, which are commonly included in marketing materials for software applications. According to some embodiments, optical character recognition (OCR) can be utilized to extract text content from the text elements, which can then be utilized by any of the techniques described herein. For example, the text content can be used to supplement, refine, etc., the keywords 105 that are provided along with the original image 104. In any case, the foreground element detection operations can involve establishing bounding boxes that correspond to the identified foreground elements.

According to some embodiments, the segmentation operations involve providing the aforementioned bounding boxes to a pre-trained segmentation model (e.g., a Segment Anything Model) to obtain refined segmentation masks (also referred to herein as “masking information 111”) that correspond to foreground elements that should be preserved. According to some embodiments, pixel entropy operations can be employed to further-refine the segmentation masks provided by the segmentation model. According to some embodiments, segment masks that correspond to high-entropy regions of the original image can be retained (e.g., those that satisfy a predefined threshold), while others can be disregarded (e.g., those that do not satisfy the predefined threshold).

According to some embodiments, the mask post-processing operations can involve implementing dilation and Gaussian blurring along the edges of the segment masks. This approach can beneficially enhance subsequent blending between the various components that are processed by the image generator 112 to generate candidate images 113 (the details of which are described below).

According to some embodiments, and as shown in FIG. 1, the image generator 112 can be configured to receive the original image 104, the keywords 105 (associated with the original image 104), and the foreground elements/masking information 111 (also associated with the original image 104). Under one example approach, the image generator 112 can implement a stable diffusion model to generate candidate images 113 based at least in part on one or more of the aforementioned inputs. For example, the image generator 112 can implement three different weights of the stable diffusion model, including a pre-trained Stable Diffusion inpainting model, a pre-trained Stable Diffusion XL (SDXL) model, and a fine-tuned Stable Diffusion model. According to some embodiments, the aforementioned models can constitute latent diffusion models for text-to-image synthesis, thereby providing a way to effectively generate new images from original images, while preserving desirable components of the original images.

According to some embodiments, the inputs to the image generator 112 can include a prompt that describes the image to be generated. According to some embodiments, the keywords 105 (and/or additional information based on the software application 103, the original image 104, the keywords 105, etc.), can be used to establish the prompt. The prompt can also be supplemented with broad terms, e.g., “best quality,” “clear image,” “abstract,” “realistic style,” and so on. Additionally, negative prompts can be incorporated to function as safeguards to help avoid undesirable components from being incorporated into the candidate images 113, e.g., “not safe for work (NSFW),” “text,” “logo,” “low quality,” “weird,” “blurry,” and so on. It is noted that the foregoing examples are not meant to be limiting, and that the prompt can include any amount, type, form, etc., of information, based on any other information, at any level of granularity, consistent with the scope of this disclosure.

According to some embodiments, the inputs to the image generator 112 can include the original image 104, to thereby enable the image generator 112 to generate candidate images 113 that align with the components of the original image 104 and its aesthetics. According to some embodiments, the inputs to the image generator 112 can further include the foreground elements/masking information 111, to thereby enable the image generator 112 to identify where inpainting should be performed (i.e., areas of the original image 104 that should be generated, modified, etc.).

The image generator 112, in conjunction with receiving the aforementioned inputs, can then generate one or more candidate images 113. According to some embodiments, the image generator 112 can implement a pre-trained aesthetic scoring model to score each generated image of candidate images 113 to ensure that it is relevant to the original image 104, that it enhances the original image 104, that it is appropriate, and so on. It is noted that the foregoing examples are not meant to be limiting, and that the score can be based on any amount, type, form, etc., of information included in candidate images 113, at any level of granularity, consistent with the scope of this disclosure.

It is noted that the image generator 112 can be implemented using additional/other approaches. For example, the image generator 112 can be configured to implement any number, type, form, etc., of AI models to generate content that is relevant to the software application 103, the original image 104, the keywords 105, and so on. For example, the image generator 112 can implement generative adversarial networks (GANs), variational autoencoders (VAEs), recurrent neural networks (RNNs), convolutional neural networks (CNNs), neuroevolution systems, deep dream systems, style transfer systems, rule-based systems, interactive evolutionary algorithms, and so on. It is noted that the foregoing examples are not meant to be limiting, and that the content agent can generate any amount, type, form, etc., of digital content, at any level of granularity, without departing from the scope of this disclosure. For example, the content can include audio content, video content, document content, web content (e.g., hypertext markup language (HTML) content), programming language content, and so on.

As a brief aside, and, according to some embodiments, the image generator 112 can be configured to implement an explanation agent (not illustrated in FIG. 1). According to some embodiments, the explanation agent can be configured to implement any number, type, form, etc., of AI models to provide explanations, annotations (e.g., within the generated images), etc., that described changes/enhancements possessed by a given generated image relative to the original image 104. To implement this functionality, the explanation agent can analyze any information, such as the original image 104, the keywords 105, the generated image, etc., and/or any other information that is relevant. In one example, the explanation for a given generated image can constitute visible bounding boxes around areas of the generated image that were modified relative to the original image 104, explanations of where, why, how, etc., the modifications were performed, and so on. This information can be provided, for example, as metadata that accompanies the generated image, such that the information can be overlaid onto/removed from the generated image using, for example, toggling options (at any level of granularity). It is noted that the foregoing examples are not meant to be limiting, and that the explanations, annotations, etc., can include any amount, type, form, etc., of information, at any level of granularity, without departing from the scope of this disclosure.

According to some embodiments, the image selector 114 can be configured to identify, among the candidate images 113 produced by the image generator 112, the candidate images 113 that are most relevant to the software application 103, the original image 104, the keyword 105, and so on. According to some embodiments, the image selector 114 can further-process the candidate images 113 based on any amount, type, form, etc., of information, at any level of granularity, to produce selected image 116. For example, the image selector 114 can implement any number, type, form, etc., of AI models to filter redundant, inaccurate, irrelevant, etc., results included in a given set of candidate images 113. The image selector 114 can also be configured to identify and eliminate any candidate images 113 that are considered to be “AI hallucinations,” which refer to the generation of false or distorted perceptions, ideas, or sensations by AI systems. This phenomenon can occur when AI models, such as LLMs, generate outputs that are not based on real data but instead originate from patterns or noise present in their training data or model architecture. Such hallucinations can manifest as incorrect information, fantastical scenarios, nonsensical sentences, or a blend of real and fabricated content.

Under one example approach, the image selector 114 can implement a pre-trained cross-modal image-text matching architecture, e.g., Learning Cross-Modality Encoder Representations from Transformers (LXMERTs), where the input text is processed by a WordPiece tokenizer and translated to word embeddings, and where candidate images 113 is processed by a Faster R-CNN object detection model and translated to an object-level image embedding. Additionally, a language encoder and object-relationship encoder can be applied to the word embeddings and detected objects, respectively. In this manner, a quality score can be predicted with a Transformer-based cross-modal encoder. According to some embodiments, the image selector 114 can be fine-tuned as a sequential model built on top of a LXMERT Encoder, and can include a linear layer, a Gaussian Error Linear Unit (GELUE) activation function, a normalization layer, another linear layer, and a sigmoid activation function as the last layer to output a binary classification prediction.

Additionally, it is noted that, under some configurations, the image selector 114 can employ an explanation agent that can be configured to provide explanations for candidate images 113 that were filtered out by the image selector 114. In turn, such explanations can be utilized in any manner to improve the manner in which the system 100 generates images. For example, the explanations can be used to improve the intelligence of the various AI models discussed herein, to demonstrate to end-users that time is being saved by intelligently eliminating certain results for good/explainable reasons, and so on.

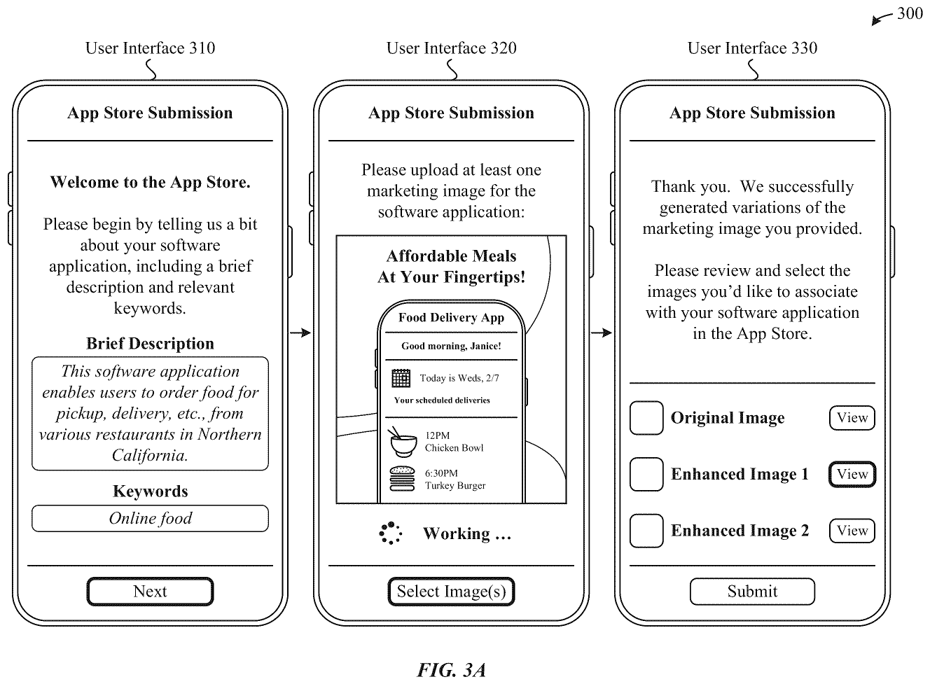

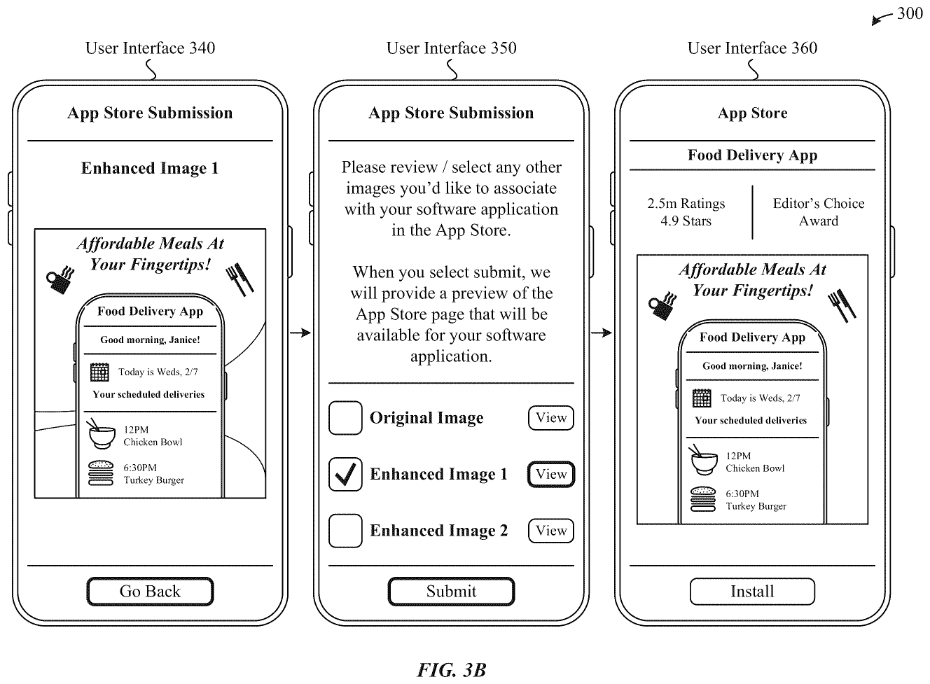

According to some embodiments, selected image 116 (output by the image selector 114) can be organized using any approach that is feasible for sending selected image 116 to the distribution entity 102 in a manner that is understood by the distribution entity 102. In turn, the distribution entity 102 can display selected image 116 using the appropriate applications, user interfaces, etc., to enable a user of the distribution entity 102 to view, interact with, etc., selected image 116. A more detailed explanation of how the distribution entity 102 can enable its user to interact with selected image 116 is provided below in conjunction with FIGS. 3A-3B.

It is noted that the logical breakdown of the entities illustrated in FIG. 1—as well as the logical flow of the manner in which such entities communicate—should not be construed as limiting. On the contrary, any of the entities illustrated in FIG. 1 can be separated into additional entities within the system 100, combined together within the system 100, or removed from the system 100, without departing from the scope of this disclosure. It is additionally noted that, in the interest of unifying and simplifying this disclosure, the described embodiments primarily pertain to mapping-based search queries 106 and selected image 116. However, it should be appreciated that the embodiments disclosed herein can be implemented to access any form of digital content, such as movies, television shows, books, documents, web pages, and so on. It is noted that the foregoing examples are not meant to be limiting, and that any amount, type, form, etc., of digital content can be accessed using the same or similar techniques to those described herein, without departing from the scope of this disclosure.

Additionally, it should be understood that the various components of the computing devices illustrated in FIG. 1 are presented at a high level in the interest of simplification. For example, although not illustrated in FIG. 1, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another.

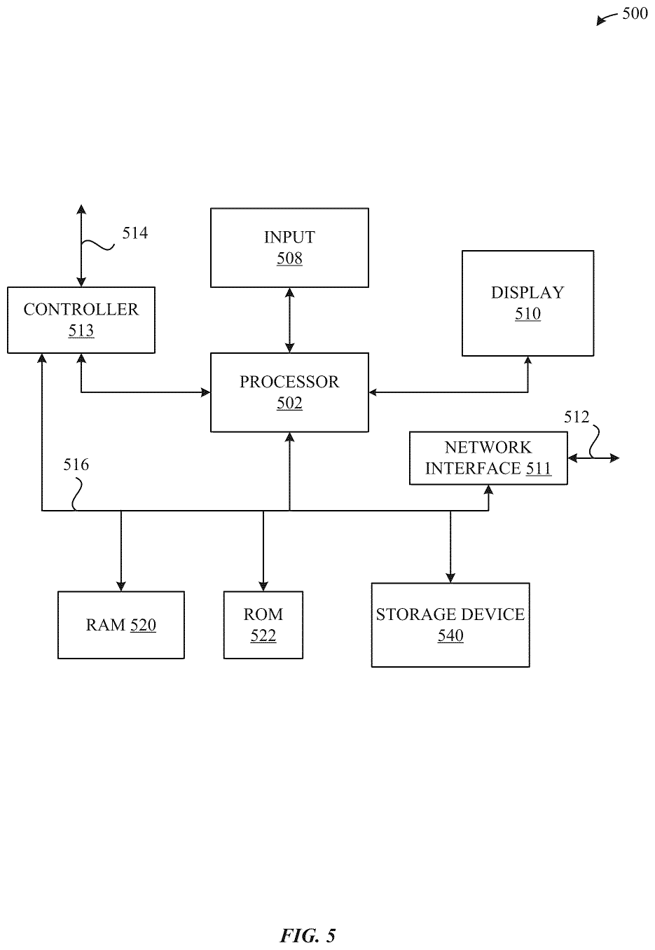

A more detailed explanation of these hardware components is provided below in conjunction with FIG. 5. It should additionally be understood that the computing devices can include additional entities that enable the implementation of the various techniques described herein without departing from the scope of this disclosure. It should additionally be understood that the entities described herein can be combined or split into additional entities without departing from the scope of this disclosure. It should further be understood that the various entities described herein can be implemented using software-based or hardware-based approaches without departing from the scope of this disclosure.

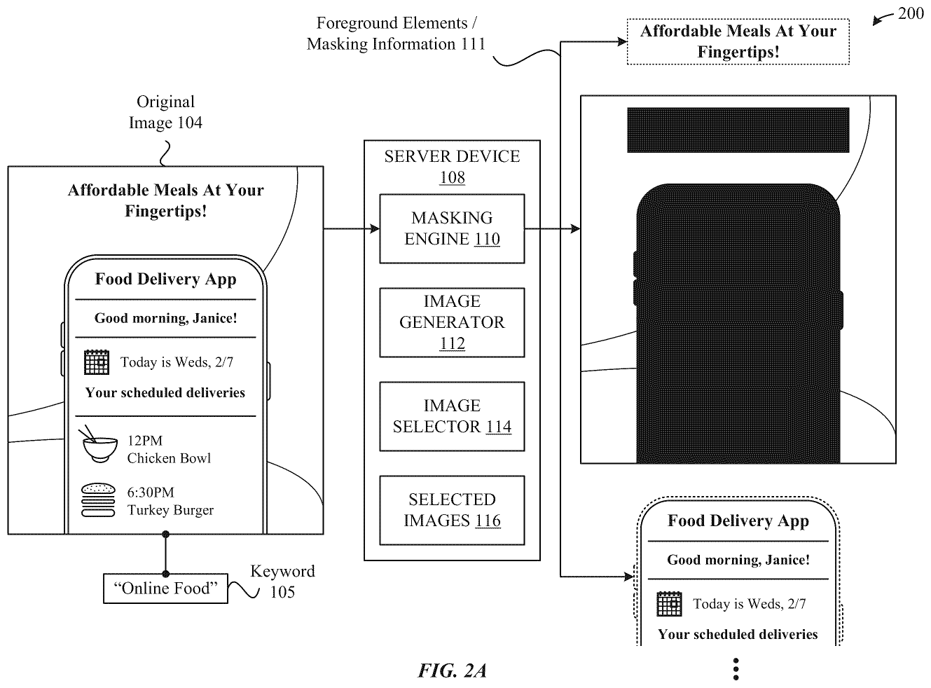

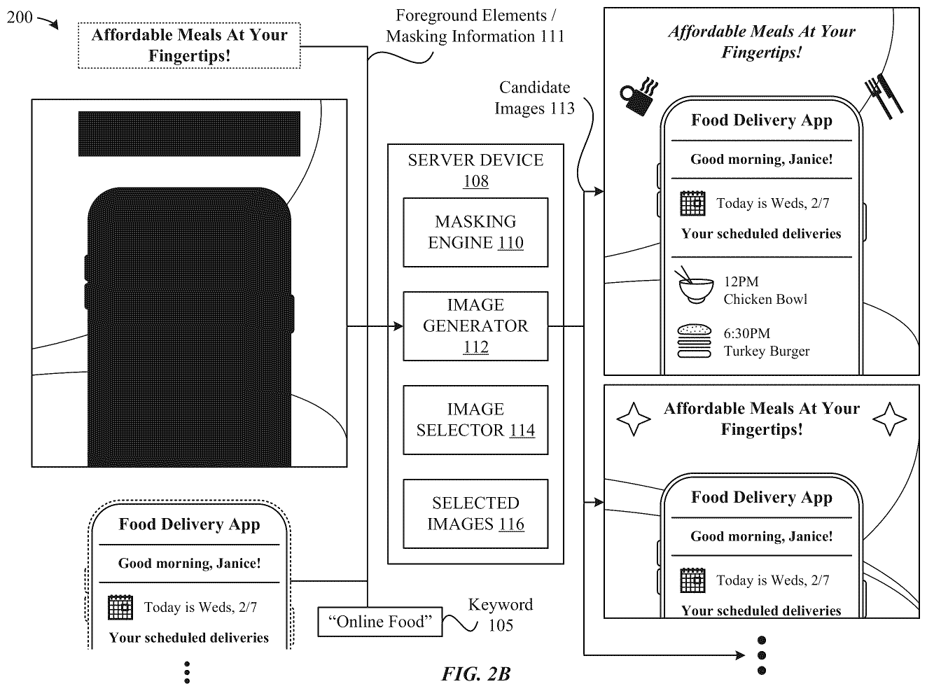

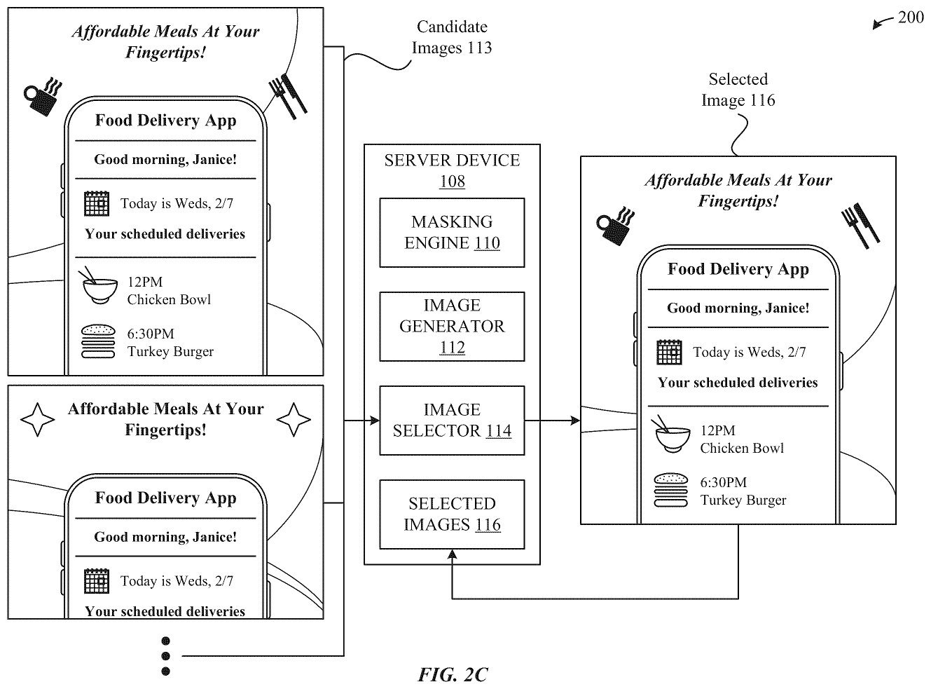

Accordingly, FIG. 1 provides an overview of the manner in which the system 100 can implement the various techniques described herein, according to some embodiments. A more detailed breakdown of the manner in which these techniques can be implemented will now be provided below in conjunction with FIGS. 2A-2C, 3A-3B, and 4.

FIGS. 2A-2C illustrate conceptual diagrams 200 for generating images associated with software applications, according to some embodiments. As shown in FIG. 2A, an original image 104, along with a correspond keyword 105, are provided (e.g., by a distribution entity 102) to the server computing device 108 (e.g., in accordance with the techniques described above in conjunction with FIG. 1). In turn, the masking engine 110 processes the original image 104 to generate foreground elements/masking information 111 (e.g., in accordance with the techniques described above in conjunction with FIG. 1). As shown in FIG. 2A, foreground elements included in foreground elements/masking information 111 include the text “Affordable Meals At Your Fingertips!” included in the original image 104, as well as the smartphone device/screenshot included in the original image 104. Masking information included in foreground elements/masking information 111 includes information that corresponds to foreground elements included in foreground elements/masking information 111, e.g., bounding boxes that identify areas in the original image 104 where the foreground elements were extracted.

Turning now to FIG. 2B, the image generator 112 receives the foreground elements/masking information 111 and the keyword 105, and generates candidate images 113 (e.g., in accordance with the techniques described above in conjunction with FIG. 1). As shown in FIG. 2B, the candidate images 113 constitute modifications of the original image 104. For example, a first candidate image of candidate images 113 can be modified to include a coffee icon and a utensil icon, and the text included in the original image 104 can be reproduced in italic form. In another example, a second candidate image of candidate images 113 can be modified to include star icons, and can also be modified to include additional/modified decorative lines in the background portion relative to the original image 104. Additional candidate images 113 can be generated, as indicated by the ellipses illustrated in FIG. 2B. It is noted that the examples illustrated in FIG. 2B are not meant to be limiting, and that the candidate images 113 can include any amount, type, form, etc., of information, based on any other information, at any level of granularity, consistent with the scope of this disclosure.

As shown in FIG. 2C, the candidate images 113 can be provided to the image selector 114. In turn, the image selector 114 can generate, based at least in part on the keyword 105, respective quality scores for the candidate images 113 (e.g., in accordance with the techniques described above in conjunction with FIG. 1). In the example illustrated in FIG. 2C, the first candidate image 113 has the strongest score (relative to the other candidate images 113), and is output as selected image 116. Selected image 116 can then be stored, for example, in a manner that effectively associates selected image 116 with the software application 103.

FIGS. 3A-3B illustrate conceptual diagrams 300 for managing images associated with software applications in an online software application store (OSAS), according to some embodiments. As shown in FIG. 3A, a user interface 310 enables a given software application 103 to be submitted to an OSAS (or, alternatively, to manage an existing software application 103 that was previously submitted to the OSAS). In the example illustrated in FIG. 3A, the user interface 310 enables a brief description of the software application 103 to be provided (e.g., one that will be displayed on a product page associated with the software application 103 within the OSAS), as well as one or more keywords 105 associated with the software application 103 to be provided.

As shown in FIG. 3A, when the “Next” button is selected, a user interface 320 displays a prompt to upload at least one marketing image that was generated for the software application 103 (i.e., one or more of original image 104 associated with the software application 103). In turn, the “Select Image(s)” option can enable original image 104 to be uploaded. The user interface 320 can then indicate to the distribution entity 102 that the original image 104 is being processed.

As shown in FIG. 3A, a user interface 330 can indicate that the original image 104 was processed, and that variations of the original image 104—i.e., selected image 116, illustrated in FIG. 3A as “Enhanced Image 1” and “Enhanced Image 2”-were successfully generated based on the submissions. The user interface 330 also enables “Enhanced Image 1” and “Enhanced Image 2” to be viewed (as well as the original image 104 for comparison purposes). As shown in FIG. 3A, a selection is received to view Enhanced Image 1-which, as shown in FIG. 3B, causes a preview of “Enhanced Image 1” to be displayed within a user interface 340. In turn, the “Go Back” option is selected, which causes a user interface 350 to be displayed, where the user interface 350 provides an option to select different images to be associated with the software application 103.

As shown in FIG. 3B, the option to associate Enhanced Image 1 with the software application 103 is selected. In turn, the “Submit” button is selected, where, in turn, a user interface 360 displays a product page within the OSAS for the software application 103. As shown in FIG. 3B, the product page includes Enhanced Image 1, which beneficially constitutes an enhancement to the original image 104 with exceptionally little input, work, etc., required from the distribution entity 102.

It is noted that the user interfaces illustrated in FIGS. 3A-3B are merely exemplary and should not be construed as limiting. On the contrary, the user interfaces can be adapted to display any amount, type, form, etc., of information, at any level of granularity, consistent with the scope of this disclosure. Additionally, it is noted that the software application submission process (or software application management process) in FIGS. 3A-3B is illustrated/described at a high level in the interest of simplifying this disclosure. In that regard, those having ordinary skill in the art should appreciate that the submission process can include fewer or additional steps, at any level of granularity, consistent with the scope of this disclosure.

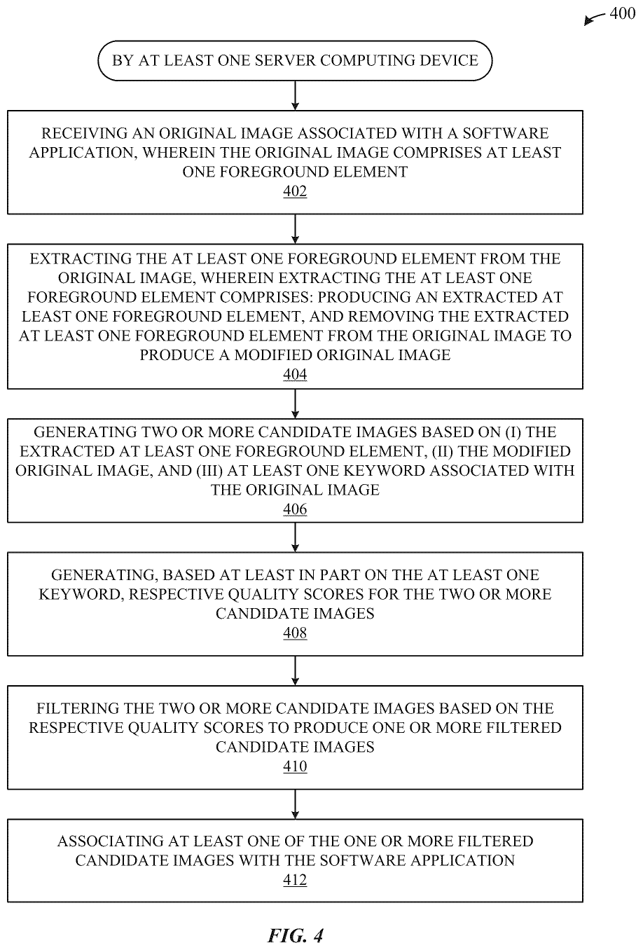

FIG. 4 illustrates a method 400 for generating images associated with software applications, according to some embodiments. As shown in FIG. 4, the method 400 begins at step 402, where server computing device 108 receives an original image associated with a software application, where the original image comprises at least one foreground element (e.g., as described above in conjunction with FIG. 2A).

At step 404, server computing device 108 extracts the at least one foreground element from the original image, where extracting the at least one foreground element comprises: producing an extracted at least one foreground element, and removing the extracted at least one foreground element from the original image to produce a modified original image (e.g., as described above in conjunction with FIG. 2A).

At step 406, server computing device 108 generates two or more candidate images based on (i) the extracted at least one foreground element, (ii) the modified original image, and (iii) at least one keyword associated with the original image (e.g., as described above in conjunction with FIG. 2B). At step 408, server computing device 108 generates, based at least in part on the at least one keyword, respective quality scores for the two or more candidate images (e.g., as described above in conjunction with FIG. 2C).

At step 410, server computing device 108 filters the two or more candidate images based on the respective quality scores to produce one or more filtered candidate images (e.g., as described above in conjunction with FIG. 2C). At step 412, server computing device 108 associates at least one of the one or more filtered candidate images with the software application (e.g., as described above in conjunction with FIG. 2C).

FIG. 5 illustrates a detailed view of a computing device 500 that can be used to implement the various components described herein, according to some embodiments. In particular, the detailed view illustrates various components that can be included in the distribution entity 102, the server computing device 108, the knowledge sources 118, and so on, described above in conjunction with FIG. 1.

As shown in FIG. 5, the computing device 500 can include a processor 502 that represents a microprocessor or controller for controlling the overall operation of computing device 500. The computing device 500 can also include a user input device 508 that allows a user of the computing device 500 to interact with the computing device 500. For example, the user input device 508 can take a variety of forms, such as a button, keypad, dial, touch screen, audio input interface, visual/image capture input interface, input in the form of sensor data, etc. Furthermore, the computing device 500 can include a display 510 (screen display) that can be controlled by the processor 502 to display information to the user. A data bus 516 can facilitate data transfer between at least a storage device 540, the processor 502, and a controller 513. The controller 513 can be used to interface with and control different equipment through an equipment control bus 514. The computing device 500 can also include a network/bus interface 511 that couples to a data link 512. In the case of a wireless connection, the network/bus interface 511 can include a wireless transceiver.

The computing device 500 also includes a storage device 540, which can comprise a single disk or a plurality of disks (e.g., SSDs), and includes a storage management module that manages one or more partitions within the storage device 540. In some embodiments, storage device 540 can include flash memory, semiconductor (solid state) memory or the like. The computing device 500 can also include a Random-Access Memory (denoted as RAM 520) and a Read-Only Memory (denoted as ROM 522). ROM 522 can store programs, utilities, or processes to be executed in a non-volatile manner. RAM 520 can provide volatile data storage, and stores instructions related to the operation of the computing devices described herein.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method for managing images associated with software applications, the method comprising, by a computing device:
receiving an original image associated with a software application, wherein the original image includes at least one foreground element;
extracting the at least one foreground element from the original image, wherein extracting the at least one foreground element comprises:
producing an extracted at least one foreground element, and
removing the extracted at least one foreground element from the original image to produce a modified original image;
generating two or more candidate images based on the extracted at least one foreground element, the modified original image, and at least one keyword associated with the original image;
generating, based at least in part on the at least one keyword, respective quality scores for the two or more candidate images;
filtering the two or more candidate images based on the respective quality scores to produce one or more filtered candidate images; and
associating at least one of the one or more filtered candidate images with the software application.

2. The method of claim 1, wherein the at least one foreground element comprises:
a screenshot of the software application;
a hardware device on which the software application is capable of executing;
descriptive text associated with the software application; or
some combination thereof.

3. The method of claim 1, wherein the modified original image includes masking information that corresponds to the extracted at least one foreground element.

4. The method of claim 1, further comprising, prior to associating the at least one of the one or more filtered candidate images with the software application:
providing the one or more filtered candidate images for selection; and
receiving a selection of the at least one of the one or more filtered candidate images.

5. The method of claim 1, further comprising generating a user interface that includes an online application store profile for the software application, wherein the online application store profile includes the at least one of the one or more filtered candidate images.

6. The method of claim 1, wherein:
the original image is provided by an entity associated with the software application,
the original image is automatically generated based on one or more aspects of the software application, or
some combination thereof.

7. The method of claim 1, wherein:
the at least one keyword is provided by an entity associated with the software application,
the at least one keyword is automatically generated based on one or more aspects of the software application,
the at least one keyword is automatically generated based on the original image, or
some combination thereof.

8. The method of claim 1, wherein generating a given candidate image of the two or more candidate images based on (i) the extracted at least one foreground element, (ii) the modified original image, and (iii) the at least one keyword associated with the original image comprises:
generating or obtaining, based on the at least one keyword, at least one additional element; and
blending the at least one additional element, the extracted at least one foreground element, and the modified original image to produce the given candidate image.

9. A non-transitory computer readable storage medium configured to store instructions that, when executed by at least one processor included in a computing device, cause the computing device to manage images associated with software applications, by carrying out steps that include:
receiving an original image associated with a software application, wherein the original image includes at least one foreground element;
extracting the at least one foreground element from the original image, wherein extracting the at least one foreground element comprises:
producing an extracted at least one foreground element, and
removing the extracted at least one foreground element from the original image to produce a modified original image;
generating two or more candidate images based on the extracted at least one foreground element, the modified original image, and at least one keyword associated with the original image;
generating, based at least in part on the at least one keyword, respective quality scores for the two or more candidate images;
filtering the two or more candidate images based on the respective quality scores to produce one or more filtered candidate images; and
associating at least one of the one or more filtered candidate images with the software application.

10. The non-transitory computer readable storage medium of claim 9, wherein the at least one foreground element comprises:
a screenshot of the software application;
a hardware device on which the software application is capable of executing;
descriptive text associated with the software application; or
some combination thereof.

11. The non-transitory computer readable storage medium of claim 9, wherein the modified original image includes masking information that corresponds to the extracted at least one foreground element.

12. The non-transitory computer readable storage medium of claim 9, wherein the steps further include, prior to associating the at least one of the one or more filtered candidate images with the software application:
providing the one or more filtered candidate images for selection; and
receiving a selection of the at least one of the one or more filtered candidate images.

13. The non-transitory computer readable storage medium of claim 9, wherein the steps further include generating a user interface that includes an online application store profile for the software application, wherein the online application store profile includes the at least one of the one or more filtered candidate images.

14. The non-transitory computer readable storage medium of claim 9, wherein:
the original image is provided by an entity associated with the software application,
the original image is automatically generated based on one or more aspects of the software application, or
some combination thereof.

15. The non-transitory computer readable storage medium of claim 9, wherein:
the at least one keyword is provided by an entity associated with the software application,
the at least one keyword is automatically generated based on one or more aspects of the software application,
the at least one keyword is automatically generated based on the original image, or some combination thereof.

16. The non-transitory computer readable storage medium of claim 9, wherein generating a given candidate image of the two or more candidate images based on the extracted at least one foreground element, the modified original image, and the at least one keyword associated with the original image comprises:
generating or obtaining, based on the at least one keyword, at least one additional element; and
blending the at least one additional element, the extracted at least one foreground element, and the modified original image to produce the given candidate image.

17. A computing device configured to manage images associated with software applications, the computing device comprising:
at least one processor; and
at least one memory storing instructions that, when executed by the at least one processor,
cause the computing device to carry out steps that include:
receiving an original image associated with a software application, wherein the original image includes at least one foreground element;
extracting the at least one foreground element from the original image, wherein extracting the at least one foreground element comprises:
producing an extracted at least one foreground element, and
removing the extracted at least one foreground element from the original image to produce a modified original image;
generating two or more candidate images based on the extracted at least one foreground element, the modified original image, and at least one keyword associated with the original image;
generating, based at least in part on the at least one keyword, respective quality scores for the two or more candidate images;
filtering the two or more candidate images based on the respective quality scores to produce one or more filtered candidate images; and
associating at least one of the one or more filtered candidate images with the software application.

18. The computing device of claim 17, wherein the at least one foreground element comprises:
a screenshot of the software application;
a hardware device on which the software application is capable of executing;
descriptive text associated with the software application; or
some combination thereof.

19. The computing device of claim 17, wherein the modified original image includes masking information that corresponds to the extracted at least one foreground element.

20. The computing device of claim 17, wherein the steps further include, prior to associating the at least one of the one or more filtered candidate images with the software application:
providing the one or more filtered candidate images for selection; and
receiving a selection of the at least one of the one or more filtered candidate images.
